(19) United States
(12) Patent Application Publication
(10) Pub. No.: US 2009/0049547 A1
(43) Pub. Date: Feb. 19, 2009

(54) System for real-time intrusion detection of SQL injection web attacks

(76) Inventor: Yuan Fan, Cupertino, CA (US)

Correspondence Address: JAMES CAI;Schein & Cai LLP, SUITE 315, 100 CENTURY CENTER COURT, SAN JOSE, CA, 95112, US

(21) Appl. No.: 11/891,612

(22) Filed: Aug. 13, 2007

(51) Int. Cl. G08B 23/00

(52) U.S. Cl. 726/22

(57) ABSTRACT

A real-time anomaly SQL Injection detection system is provided to detect anomalies specific to the backend Database layer and the Web application layer of a Website. To reduce false alarms, the system correlates abnormal scores for the Database layer and Web application layer to detect and catch different forms of SQL injection attacks. The attacks are detected based on anomalies and not signatures or patterns.

### BACKGROUND OF THE INVENTION

1. Field of the Invention

This invention relates generally to the field of intrusion detection of SQL injection web attacks, and more specifically, to a system for standard query language (SQL) injection attack detection which has low false alarms, as well as, a high detection rate.

2. Background

Anomaly network intrusion detection uses a different approach in that it compares the current data and the previous gained “normal behavior” and detects the novel data if the difference between the two is beyond a margin. One of the advantages of the Anomaly intrusion detection is that it has no need of a big signature database.

Signature based intrusion detection systems (IDS) is the most popular system used in the current world, due to the fact that it can catch a known network attack very quickly and accurately. However, signature based IDS is also very vulnerable to unknown attacks, since the signature is a hard match, even when the attacker modifies the attack a little. Thus, the attacker can evade the signature based IDS very easily.

One the other hand, the Anomaly network intrusion detection can be effective on unknown network attacks or a similar known attack which tries to evade the signature based IDS. However, a disadvantage of Anomaly network intrusion detection is a very high false alarm rate which is unusable in the real world.

By 2000, the World Wide Web (Web) traffic completely overshadowed other applications and has become the most popular protocol used in the world. Because of the popularity of the Web, more and more business transactions and communications are now delivered over the Web, and more and more people prefer to use the Web to do their favorite things: online shopping, bank transaction, web email, etc.

At the same time, the security issues of the Web has also become one of the hottest topics. As those people who invented the Web never realized the Web could achieve such tremendous success today, they might not have neglected the Web security issues at the very beginning. Another reason that Web applications and services have become the fastest growing area of new attacks is that more and more hackers are turning their attentions to the common weaknesses in Web applications. Although many companies have put a lot of effort to deal with those security issues, there are so many Web application vulnerabilities with very little defense. And there are new Web attacks coming out now and then. The 2002 Computer Security Institute (CSI) Computer Crime and Security Survey revealed that, on a yearly basis, over half of all databases experience some kind of breach and the average breach results in close to $4 million in losses. The survey also noted that Web crime has become commonplace. Web crimes range from cyber-vandalism (e.g., Web-site defacement) at the low end, to theft of proprietary information and financial fraud at the high end.

Interesting enough, Hypertext Transfer Protocol (HTTP) and web application is probably the most vulnerable part on the Web, due to the wide use of the Internet as well as the little consideration of security when the HTTP, the Common Gateway Interface (CGI) and the web application were created. Another reason for this is that firewalls almost always allow (passes) all traffic going through the HTTP port 80 (or 8080, HTTPs port 443, etc.).

Unlike other protocols, the attacks against the Web vary from the Operating System (OS) level, Web server level to the application/database level. These attacks include: Invalidated Input, Buffer overflow, Cross-Site Scripting (XSS) Attack, Denial of Service, Session Hijacking, and SQL injection.

Among all the attacks, the SQL injection is one of the most popular attacks. The trend of the Web attack can be likened to automation, fast vulnerability finding and attack. Most of the time only a browser and an internet connection is needed by the attacker. However, there are additional tools that can be used for fast vulnerability scanning and finding.

SQL Injection is one-type of web attack which only needs a web browser, and attacks the web application (like ASP, JSP, PHP, CGI, etc) itself rather than the Web server or services running in the OS. Even though the web applications are different from each other, their main architecture remains very similar. By way of example, if the parameter is not properly validated or handled by the web application, it is always possible to inject mal-formed parameters which will finally result a special SQL constructed by the web application being sent to a database. Many web applications take parameters from the Web user, and make SQL queries to the database. Take for instance when a user logs in to a website from its Web page. The Web page takes the entered user name and password and makes a SQL query to the database to check if a user has a valid name and password. With SQL Injection, it is possible to send a crafted user name and/or password field that will change the SQL query and thus let the attacker login successfully.

| Input Parameter | Username | Password |
|---|---|---|
| Normal case | John | John12345 |
| SQL Injection case | Joe | J’ or ‘1’=’1 |

The process for a SQL Injection works due to the conditions when meet together as described below. First, a Web application did not validate the input parameter at all or not enough. And will use the input values to construct a SQL directly. Second, the SQL is constructed by the Web application simply with the input parameter without any additional action such as check the length or remove the special characters. The Web application still creates a SQL query based on the bogus input parameter in the Web application layer and sends it to the database layer to execute. For example, in a login case, the SQL may get constructed by selecting a USERID from a USERPROFILE where USERNAME=‘$username’ and password=‘$password’. In this login example, when the parameters get filled in, the constructed SQL will select USERID from USERPROFILE where username=‘Joe’ and password=‘J’ or ‘1’=‘1’. The ‘1’=‘1’ generally guaranties that the condition will always return true, so the attacker gets validated by the login web application.

To detect SQL Injection attacks, many people tried to use signature based approach which is one of the following: 1) detect to see if there is special character to watch; 2) detect to see if some known pattern inside the input parameters, such as 1=1, ‘a’=‘a, etc.; and 3) similar to #2, any known patterns that have been published can be put into a watch list, or using regular expression to do a partial pattern matching to try to catch more patterns.

Even though the above signatures can detect some SQL Injection attacks, the limitation is very obvious. The limitations include: 1) can only detect the known SQL Injection patterns; 2) new SQL Injection attack techniques are being found and may have different patterns; and 3) existing SQL injection attacks can have all kinds of different variations and evasion techniques which are very popular.

A pure signature based detection technique has a very high false alarm rate or is very ineffective. For example, the legitimate user may input some special characters too. Thus, if the system tries to simply judge by special characters, then this simple judgment will result into very high false alarms. If the system tries to catch exact known patterns such as 1=1, then it is inefficient since the attackers can change to z=z or jf8rut=jf8rut. As can be appreciated, it is almost impossible for the system to iterate all the possible patterns in a time efficient manner.

There is therefore a need in the art for techniques to detect web application SQL injection attacks with low false alarms, as well as, a high detection rate.

### SUMMARY OF THE INVENTION

In view of the limitations now present in the prior art, the present invention provides a new and useful advanced anomaly SQL Injection detection system with correlation of a Database layer and web application layer intrusion detection which is more accurate, powerful and has low false alarms.

An object of the present invention is to provide a new way of anomaly intrusion detection that detects for an anomaly based on at least status codes, parameter lengths, Intraffic, OutTraffic. Special characters are also evaluated.

A further object of the present invention is to provide an anomaly SQL Injection detection system with correlation of a Database layer and web application layer to detect for the most severe modem web application attacks—SQL injection, while lowering the false alarms.

The still further object of the present invention is to provide a computer program product including a computer readable medium having instructions causing a computer to: learn normal Database and Web application standard query language (SQL) query data for a website; capture real-time Database and Web application SQL query data for the website; and detect an anomaly representative of an SQL injection attack based on the normal Database and Web application SQL query data and the real-time Database and Web application SQL query data.

A still further object of the present invention is to provide a system comprising: means for the learning normal Database and Web application standard query language (SQL) query data for a website. The system also includes means for capturing real-time Database and Web application SQL query data for the website; and means for detecting an anomaly representative of an SQL injection attack based on the normal Database and Web application SQL query data and the real-time Database and Web application SQL query data.

A further object of the present invention is to provide a system comprising: a processor operable to execute a sequence of instructions to learn normal Database and Web application standard query language (SQL) query data for a website in a learning mode, capture real-time Database and Web application SQL query data for the website in a detection mode, and detect an anomaly representative of an SQL injection attack based on the normal Database and Web application SQL query data and the real-time Database and Web application SQL query data in the detection mode. The system further includes a memory coupled to the processor for storing the results from the learning mode and detection mode.

A further object of the present invention is to provide a system with a process which determines a joint score based on an anomaly score for the Database layer and an anomaly score for the Web application layer.

A principal object of the present invention is to provide a flexible and accurate method to detect different web application security (SQL injection attacks related) demands that will overcome the deficiencies of the prior art devices.

An object of the present invention is to provide a low false alarm detection rate.

Another object of the present invention is to provide an anomaly SQL Injection detection system with correlation of a Database layer and web application layer intrusion detection that does not need to know the attack signature/pattern and can detect 0-day attacks which are brand new attacks. The system has no prediction as to what a signature/pattern attack looks like.

A further object present invention is to provide a system which is configurable to detect other web application attacks such as Cross site scripting, etc. which are subject to attacks by manipulating the parameters.

Other advantages and object of the present invention will become apparent or obvious from the detailed description, illustrations and claims contained herein.

### BRIEF DESCRIPTION OF THE DRAWINGS

The embodiments of the disclosure will become more apparent from the detailed description set forth below when taken in conjunction with the drawings in which like reference characters identify corresponding like elements throughout.

FIG. 1 illustrates a general block of a real-time anomaly SQL injection detection system in accordance with the present invention.

FIG. 2 illustrates the system of FIG. 1 in a website to detect a real-time anomaly SQL Injection web application attack.

FIG. 3 illustrates a general block diagram of the real-time anomaly SQL injection detector in accordance with the present invention.

FIG. 4A illustrates a general block diagram of collected Web layer attributes in accordance with the present invention.

FIG. 4B illustrates a general block diagram of collected Database layer attributes in accordance with the present invention.

FIG. 5 illustrates a general flowchart of the training process when the system is in the training mode in accordance with the present invention.

FIG. 6 illustrates a general block diagram of neural network parameters.

FIG. 7 illustrates a general flowchart of the normalization process in accordance with the present invention.

FIG. 8 illustrates a general block diagram of the normalizing and scoring module in accordance with the present invention.

FIG. 9 illustrates a general representation of a view inside a backend Database with the normal visited objects denoted by solid lines and an abnormal (anomaly) pattern denoted by a dashed line.

FIG. 10 illustrates a general block representation of the correlation between the Web application (layer) and the Database layer.

### DETAILED DESCRIPTION OF THE INVENTION

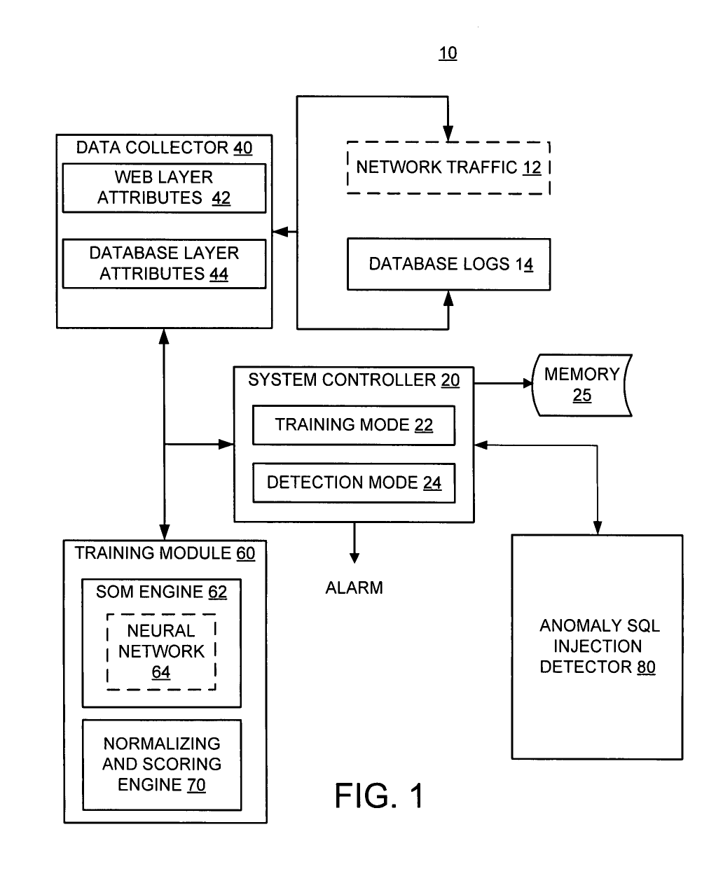

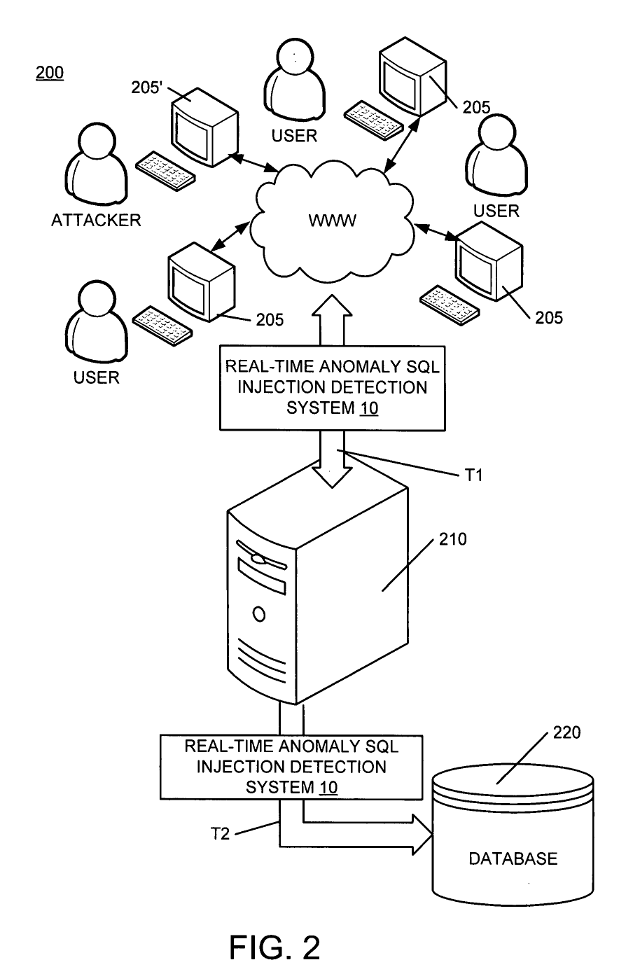

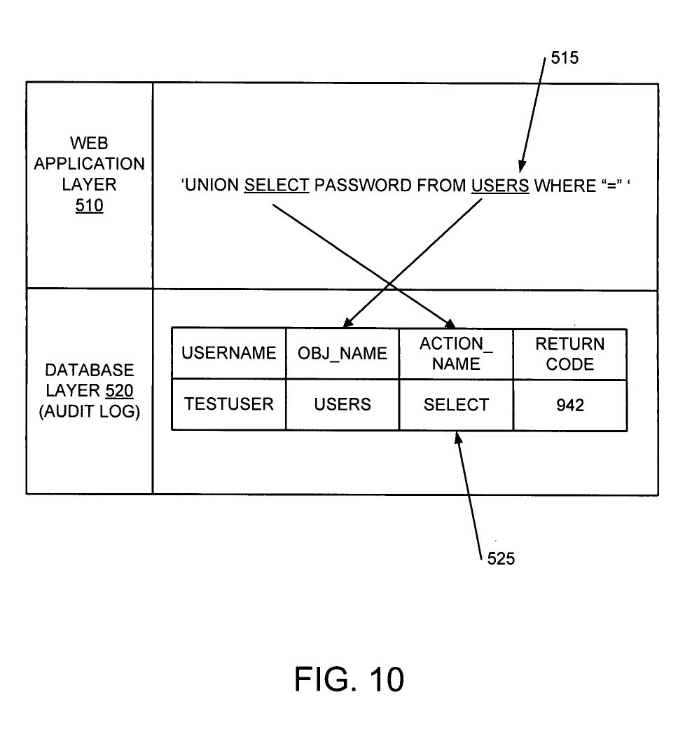

Referring now to the drawings, and specifically to FIG. 1, the real-time anomaly SQL injection detection system in accordance with the present invention is generally referenced by the numeral 10. The system 10 is constructed and arranged to detect anomaly SQL injections with a high rate of accuracy and with few false alarms by correlating the Database layer 520 and the Web application layer 510, as best seen in FIG. 10. The Database layer 520 corresponds to a backend Database 220 of FIG. 2. The Web application layer 510 corresponds to the Web application executed by Web server 210 or other computing device.

FIG. 2 illustrates the system 10 of FIG. 1 in a Website 200 to detect a real-time anomaly SQL Injection attack. The Website 200 includes a Web server 210 having the Web application to provide the users via computers 205, such as a Personal Computer, Laptop, Notebook PC, Tablet PC or other computing device with a Web browser. Among the users that wish to access the Website 200 is an attacker which has a computer 205′ having a Web browser. Other tools may be used by the attacker to detect vulnerabilities of the Website 200.

With reference again to FIG. 1, the system 10 includes a system controller 20 coupled to a data collector 40, a training module 60 and an anomaly SQL injection detector 80. In general operation, the system 10 extracts and collects data via the data collector 40 from network traffic 12 or from the Database Logs 14. The system 10 has a training mode 22 to learn the normal behavior from a set of collected data during a training period. During the training mode 22, the normal behavior of the Web application layer 510 and the Database layer 520 is learned. The system 10 also has a detection mode 24 to detect any real-time anomaly SQL injection attacks. If such an attack is detected, the system controller 20 can generate an alarm, denoted as ALARM, indicative of abnormal behavior and/or to stop the potentially malicious behavior. The system controller 20 is a processor or other computing device found in a computer, server, etc. Thus, the system controller 20 may perform one or more of the processes described herein contemporaneously, in parallel, series or in a different order.

The system controller 20 is coupled to memory 25 for storing the data and resultant data described herein below.

### 1. Collection Process

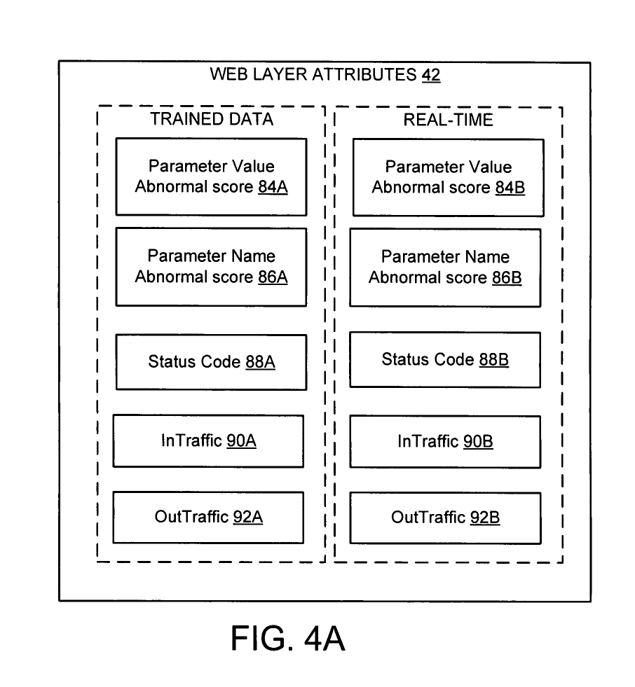

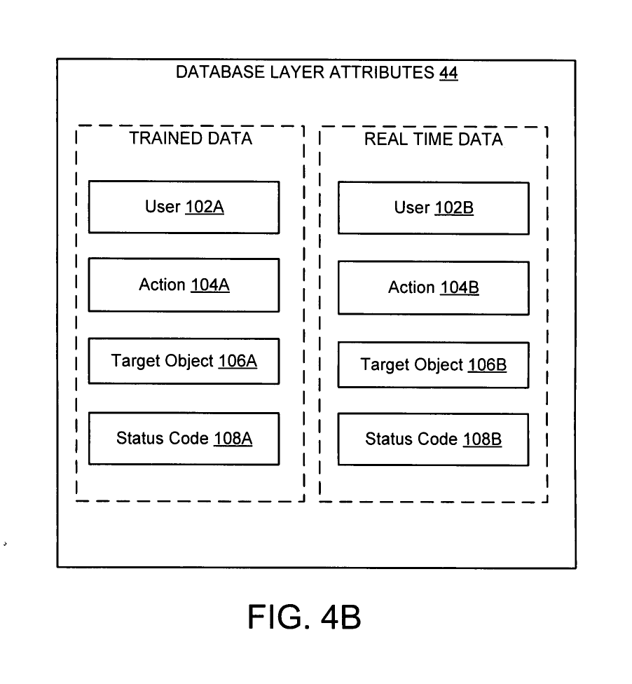

The data collector 40 detects for Web layer attributes 42 and Database layer attributes 44 in the training and detection modes 22 and 24 processed by the system controller 20. The data collector 40 can collect the Web layer attributes 42 by either capturing the network TCP/IP traffic TI (transmission control protocol/internet protocol) or obtaining data from the Web server logs. When the data collector 40 collects the database layer attributes 44, the data collector 40 may use the Database audit logs. A list of the Web layer attributes 42 is shown in FIG. 4A. The data collector 40 stores the results of the data collection in memory denoted by a list of Web layer attributes 42 (FIG. 4A) and a list of exemplary Database layer attributes 44 (FIG. 4B).

In FIG. 4A, a list of exemplary Web layer attributes 42 includes Parameter Value Abnormal Score 84A, Parameter Name Abnormal Score 86A, Status Code 88A, InTraffic 90A, and OutTraffic 92A for learned (trained) data. This information may be collected by the data collector 40 based on the network traffic 12. In FIG. 2, the network traffic 12 is denoted as the arrow labeled Ti. During the detection mode, the list of the Web layer attributes 42, in real-time, includes Parameter Value Abnormal Score 84B, Parameter Name Abnormal Score 86B, Status Code 88B, InTraffic 90B, and OutTraffic 92B.

The Parameter Value Abnormal Score 84A or 84B is generally defined, for SQL injection to happen, such that the parameter Value length will be longer than normal in most cases. The Parameter Value Abnormal Score is generated when abnormal special characters appear (such as without limitation “)” or “)”) and indicates a SQL Injection attack. As can be appreciated, other “special characters” may be used. Moreover, the Parameter Name Abnormal Score 86A or 86B is generally defined, for SQL injection to happen, such that the user or visitors score will be greater than normal in most cases. The Status Code 88A or 88B is an internal error codes indicative of at least one problem such as when the Web application fails to execute a query on the Database layer. The InTraffic 90A or 90B is defined as the request volume sent to the Web application from Client (user) or attacker. The OutTraffic 92A or 92B is defined as the return traffic from the Web server 210 to the Client side. The return traffic is denoted as the arrow labeled T1 from the Web server 210 to the World Wide Web (WWW).

The Web layer attributes 42 are for illustrative purposes and may vary based on the Web application.

How to abstract data or collect data from the Web application layer 510 and generate an abnormal score from the Web layer attributes 42 was previously described. However, just from the Web application layer 510, the system 10 may not have an exact picture of how the Web application layer 510 executed by the Web server 210 is querying/commanding the backend Database 220 or the Database layer 520. While not wishing to be bound by theory, the Database layer attributes 44 of the Database layer 520 may be important additional proof to judge or evaluate if a real attack is going on and the behavior/damage of such an attack.

There are several ways to collect the Database layer attributes 44. By way of example, the Database layer attributes 44 may be collected by sniffering the traffic denoted by the bi-direction line T2 between the Web server 210 and the backend Database 220. Another way to collect the data for the Database layer attributes 44 is from the backend Database 220 itself via an auditing feature or a certain area which contains the SQL action data needed by system 10.

Referring now to FIG. 4B, a list of exemplary Database layer attributes 44 collected, in the training mode, includes User 102A, Action 104A, Target Object 106A and Status Code 108A. A list of exemplary Database layer attributes 44 collected in real-time, during the detection mode, includes User 102B, Action 104B, Target Object 106B and Status Code 108B. In the exemplary embodiment, the User 102A or 102B represents the Database user executing a SQL action. The Action 104A or 104B includes predetermine actions such as select, insert, delete or update or create object actions in the Database. The Target object 106A or 106B includes the table or view being queried. The Status code 108A or 108B indicate whether the query was a success.

The Database layer attributes 44 are for illustrative purposes and may vary based on the backend Database 220.

### 2. Training Process

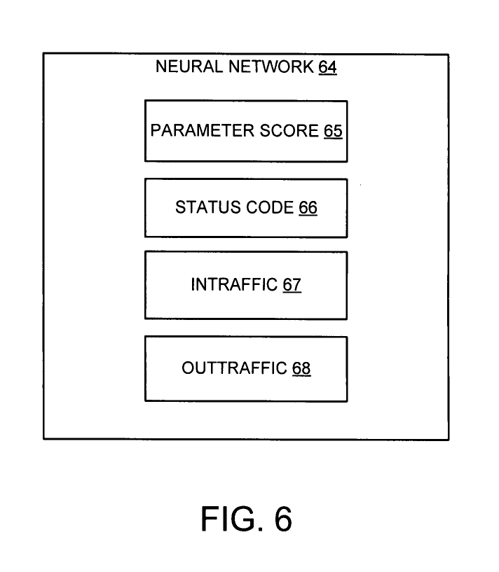

Referring now to FIG. 6, during the training (process) mode 22, a neural network 64 is generated for each CGI-URL where URL is the Uniform Resource Locator for use in the WWW and CGI is the common gateway interface. The neural network 64 contains the following: Parameter score 65; a (http) Status Code 66; (http) InTraffic 67 and (http) OutTraffic 68 (where http represents hypertext transfer protocol). The parameter score 65 can be generated based on a Parameter length, a Parameter name, and a parameter value. The longer the parameter variant from the trained normal parameter length, the parameter score may be determined to be an abnormal score. Similarly, the mechanism applies to the parameter value.

By way of example, “obj-name” or “users” is the same as a “parameter name” Parameter Value is the value of a parameter. The “parameter name” have associated therewith a value length. Moreover, the parameter scores, status code, InTraffic and OutTraffic are independently obtained from a “http” request.

A hacker or anomaly is by comparing the real time “user” visit score of these attributes to the previously clean environment (training score) of the user. If the difference is greater then some threshold, an anomaly and/or hacker is detected.

The database layer attributes and the web application attributes are collected for each user or visitor. Therefore, InTraffic and OutTraffic is also specific to a particular user to detect when an attacker is sending different strings.

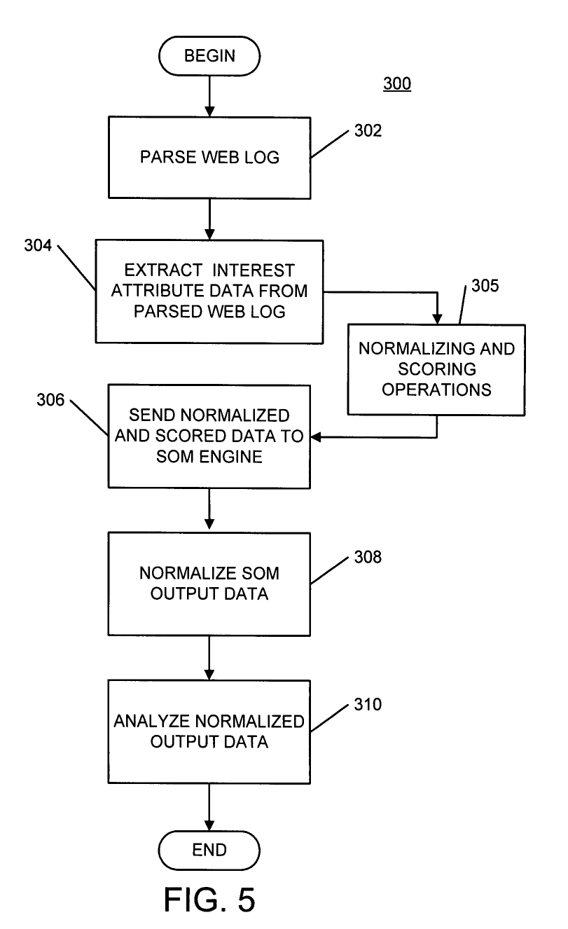

Both the data collection process by the data collector 40 and the training process 300 (FIG. 5) are configurable for determining which attributes are need to be feed into the neural network 64. In the exemplary embodiment, the parameter score, the http-status-code, the in-traffic, and the out-traffic were extracted.

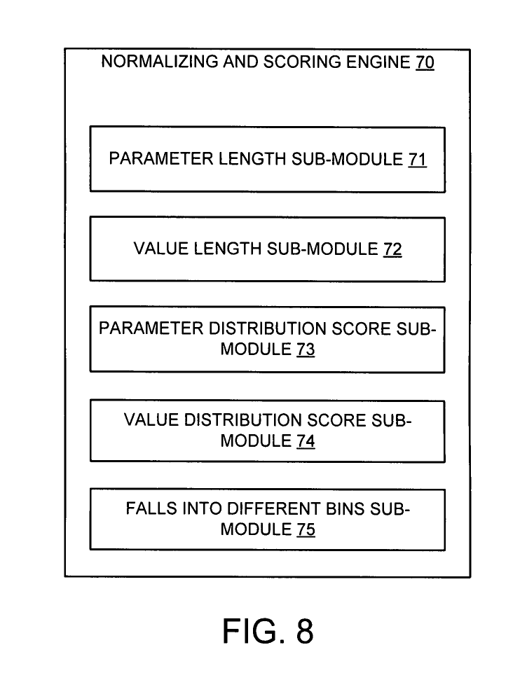

Referring now to FIG. 5, a general flowchart of the training process 300 is shown. The training process begins with step 302 where the network traffic 12 or the Web log are parsed. Step 302 is followed by step 304 where parameters of interest are extracted. The list of extracted parameters from the network traffic 12 was described above. Step 304 is followed by step 305 where the data is normalized and scored in accordance with the operation of the normalizing and scoring engine 70 (See. FIG. 8). Step 305 is followed by step 306 where the results from the normalizing and scoring engine are sent to the SOM (Self Organization Map) engine 62 of the training module 60. The SOM (Self Organization Map) engine 62 is one type of neural network. The SOM engine 62 processes the extracted attributes and then generates the SOM data output.

Step 306 is followed by step 308 where the SOM output data is normalized by the Normalizing and Scoring engine 70 to generate Normalized data. Normalization is needed when different parameters have different data range levels. For example, if the parameter score range is from 0-10 and the (http) status code range is from 0-500, then certain normalization is need to prevent one attribute from contributing more than other attributes (which is not desired). Step 308 is followed by step 310 where the normalized output data is analyzed. This data may be analyzed visually in graphs, reports, etc. The data may be analyzed by a computerized process.

The description of the follow chart of FIG. 5 is described in relation to training Web layer attributes 42. The process is repeated for the Database layer attributes 44.

In normal Web application usage cases, the character distribution of the extracted parameters always falls into a pattern. For example, a username contains characters, numbers and ‘−’. An ID may be made of numbers in a string. But in a SQL injection attack case, to make the injection happen successfully, the entered username will tend to have different “special characters” inside the string, such as (but not limited to), a single quota (‘), a greater than sign (>), a less than sign (<) or parenthesis signs.

A simple example of a hackers' SQL injection attack at the Web application layer is shown below in the form of a hypertext transfer protocol (http) string. The http string comprises
http://www.youweb.com/showdetail.asp?id=49 and 1=1
   where www references the World Wide Web; “youweb.com” designates the website address or page location; and the remaining characters such as “?id=49 and 1=1” is an example of an SQL injection attack data.

If there are no errors returned, then the attacker or hacker may try another SQL injection string such as
http://www.yourweb.com/show.asp?id=49 and (select count(*) from sysobjects)>0
   where the characters “?id=49 and (select count(*)from sysobjects)>0 is an example of another SQL injection attack data.

This SQL injection example is targeting the (SQL) Web server 210. Nevertheless, such a string can be a similar mechanism for other databases, just the name of the system tables/views differ. Access puts those in sysobjects.

From the above example, with SQL injection, it can be readily seen that the character distribution of parameters inside the URL will tend to appear unusual than the normal cases, in the sense of both length and the character distribution.

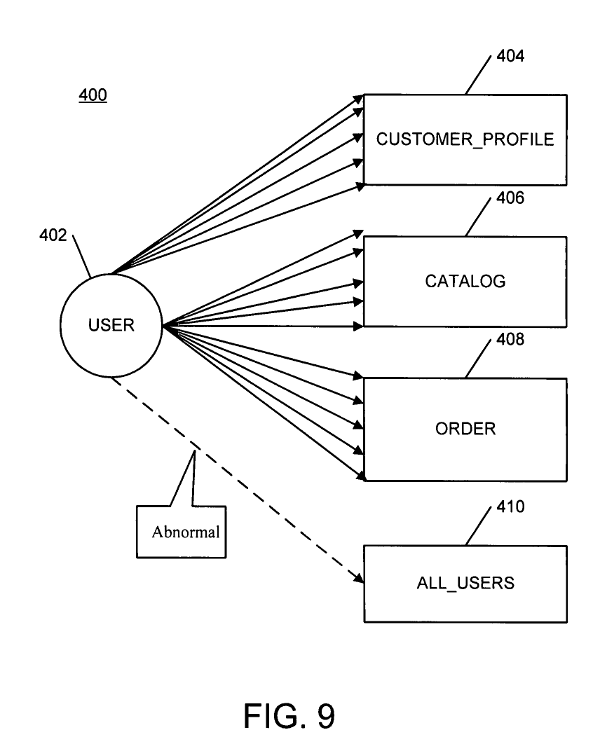

Referring now to FIG. 9, a view 400 inside the backend Database 210 is shown. The normal visited objects identify a normal visiting pattern and denoted by a solid line. The one-time visiting pattern denoted by a dashed line is abnormal or is an anomaly since the normal visiting pattern is repeated to the other objects. As we can see, with normal behavior, the Web user 402 will query the customer_profile table 404, the Catalog table 406 and the order table 408. However, the query of the all users table 410 is unusual and represents an anomaly. (The all_users table is the oracle's system table which holds the database system users information.)

A common gateway interface (CGI) allows web designers to create dynamic Website pages. For example, when a user interacts with a Web page and fills out the form by way of data entry fields, the entered information may be displayed on a next Web page displayed to the user. The CGI is also used in search engines. The CGI may be a script placed on the server, usually in a directory.

The system 10 is constructed and arranged to detect an attack at the Web layer 510 or the Database layer 520 by putting different characters of the detected string into different bins, and then calculate a novel score for each URL in a training time. Then during the detection mode 24, the system 10 will obtain the score of each CGI URL again and calculate the distance between the training ones to assign a novel score.

For each of the name/value in the CGI URL, the system 10 uses special bins to hold/represent the different characters set, set forth below

{a-zA-Z, 0-9,‘, .,;,“,”,/,\\,˜,`,!,@,#,$,%,̂,&,*,(,),−,=,<,>,?, {,},|}.

Then with each CGI/Web application, the system 10 operates in a learning or training mode to learn the normal pattern during the training period.

The Normalizing and Scoring engine 70 will now be described in relation to FIG. 8. For each CGI request URL in web log, a plurality of factors are extracted/calculated/normalized. In a parameter length sub-module 71, the factor Parameter-length is extracted, calculated and normalized. In a Values-length sub-module 72, the factor Values-length is extracted, calculated and normalized. In a Parameter distribution score sub-module 73, the factor Parameter distribution score is extracted, calculated and normalized. In a Value-distribution score sub-module 74, the factor Value-distribution score is extracted, calculated and normalized. The distribution score can be judged by how many type of occurrences of the different types of characters.

To reduce false alarms, the normalizing and scoring engine 70 places a-z, A-Z into an alphacharacter category and 0-9 as A number category. Then “special characters” such as “'”, “>”, and so forth are placed into other categories of the different bins sub-module 75. Since the assumption is that the alphacharacter category will fall into a stable pattern for a certain CGI. For example: the username might always falls into a alphacharacter and number category in normal usage. On the other hand, in the SQL injection case, there would be “special characters” such as a’ or ‘1’=‘1. Thus, a special character category and/or an unusual character category may also be used.

Normalization for the parameter value length is important so that the value length can fit into a fixed range (for example: 0-1) for overall anomaly score calculation purposes. The outcome can be defined by equation Eq.(1):

|LenR−LenA|/Max(LenR, LenA) Eq. (1)

where LenR is defined as real-time parameter value length and LenA is defined as an average parameter value length after training. If the new length is similar to a sample training length, then the result is almost close to 0, but on the other hand, if the real-time value length LenR is much bigger than LenA, then the result will come close to 1.

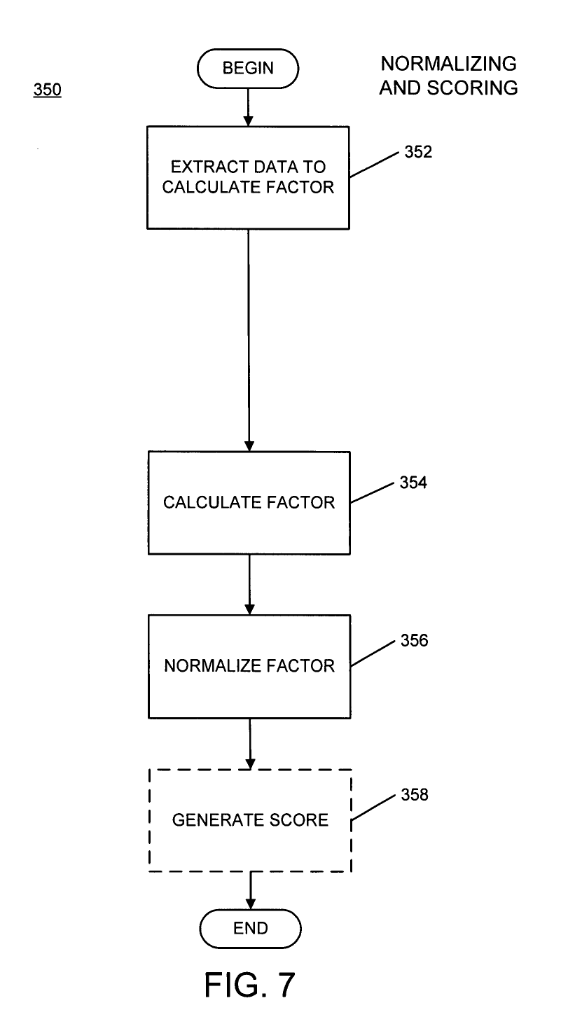

The flowchart for Normalizing and Scoring Process 350 by each sub-module is generally shown in FIG. 7. The process 350 begins with step 352 where data is extracted. Step 352 is followed by step 354 where the factor is calculated. Step 354 is followed by step 356 where the factor is normalized. In some instances a score is calculated at step 358 shown in phantom (dashed line) to indicate an optional function needed.

### 3. Detection Process

The detection mode 24 for carrying out the detection process captures the real-time data similar to the training process. The difference is that after the data gets extracted and normalized, it will be feed into the trained neural network to calculate how far is the distance between current data compares to previous “trained normal” data.

A Table representative of Web layer normal data vs. abnormally traffic caused by SQL Injection attacks is shown below.

Web normal traffic vs. Web SQL injection

| Web | | | |
|---|---|---|---|
| Training | | | |
| 203.7366092 | 9.275283 | 576.5658 | 123.1718 |
| 210.3278138 | 26.72986 | 609.3593 | 113.7122 |
| 219.3220077 | 61.41085 | 645.5216 | 103.568 |
| 221.8608458 | 169.066 | 627.1404 | 112.3334 |
| 212.3305304 | 426.5677 | 516.7143 | 151.091 |
| 203.7924397 | 639.5583 | 432.9758 | 172.911 |
| 201.1655923 | 804.7452 | 409.0698 | 159.6027 |
| 200.4134191 | 1041.625 | 403.2338 | 132.9086 |
| 200.138194 | 1261.073 | 402.2831 | 131.4284 |
| Web | | | |
| Detection | | | |
| 303.9990448 | 139.9668 | 502.1129 | 0.003258 |
| 303.9974611 | 139.9346 | 462.2181 | 0.028421 |
| 303.9994348 | 139.8615 | 447.8501 | 0.041096 |
| 303.9999107 | 139.7122 | 445.2572 | 0.067242 |
| 303.9999634 | 139.6504 | 443.2334 | 0.117713 |
| 303.9999347 | 139.7436 | 442.135 | 0.180101 |
| 303.9999999 | 139.9985 | 524.5301 | 2.34E−04 |
| 303.9999998 | 139.9924 | 523.5133 | 1.16E−04 |
| 303.9999991 | 139.9659 | 522.0063 | 6.01E−05 |

### 4. Web Layer Abnormal Score:

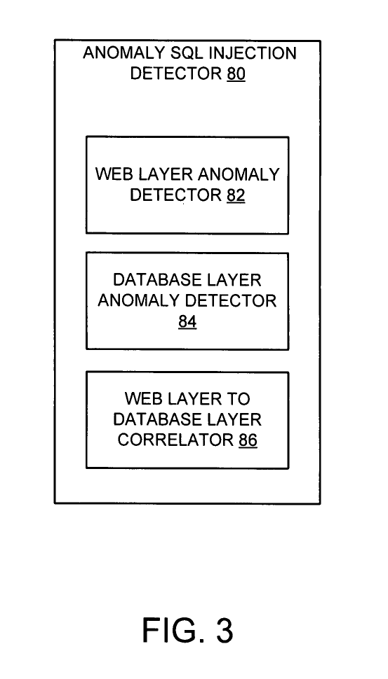

Referring now to FIG. 3, the Web layer anomaly score is calculated by a Web layer anomaly detector 82 and depends on the distance between the real-time data compared to the training data in the neural network 64 (which uses a self organization map algorithm).

### 5. Database Layer Abnormally Score:

On the other hand, the Database layer anomaly score is calculated by a Database layer anomaly detector 84. The same training and detection mechanism could apply to the Database layer 520, the difference is the categories needed to map the Web application layer 510 to the Database layer 520. An example is shown in FIG. 10. In FIG. 10, the script 515 in the Web layer 510 is correlated to columns or objects in the Database Table 525. The arrows indicate examples of correlation. For example, User in the script 515 is the Database user executing the SQL action in the Database Table 525. The Action in the script 515 corresponds to the action such as select, insert, delete or update or create object actions. The Target object in the script is the table or view is being queried. The Status code indicate whether the query was a success.

After the data is collected and trained in a clean environment, each real-time data will generate its anomaly score by comparing with the normal data in neural networks 64, for the Web application layer 510 and alternately the Database layer 520.

Both web layer anomaly detector 82 and database layer anomaly detector 84 can generate its own anomaly score with best efforts to describe the attack behavior. Thereafter, a joint score is calculated by a Web layer to Database layer correlator 86 to determine a correlation score. This correlation score between the two scores provides a more accurate way and lower the false alarm rate. Since just one layer score could lead to high false alarm due to the fact that the user parameter input can be varied and unpredictable, and in database layer the behavior is hard to have a signature to describe. There is more than one algorithm to generate the correlation score between these two layers. By way of example, if both scores are high, then the (outcome) correlation score needs to be high. However, if both scores are low, then the (outcome) correlation score needs to be lower. One possible correlation score is calculated based on Eq.(2) defined as

S=S1×S2/(S1+S2) Eq.(2)

where S1 is defined as the abnormal score of web application layer; and S2 is defined as the abnormal score of database layer. The formula can be changed as long as the output indicate the two layer correlation.

The example above was described in relation CGI. Nevertheless, the system 10 can be configured for cross site scripting.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and disks which usually reproduce data magnetically, while discs reproduce data optically with lasers. Combinations of the above should also be included within the scope of computer-readable media.

The previous description of the disclosed embodiments is provided to enable any person skilled in the art to make or use the disclosure. Various modifications to these embodiments will be readily apparent to those skilled in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. A system comprising:
means for the learning normal Database and Web application standard query language (SQL) query data for a website;
means for capturing real-time Database and Web application SQL query data for the website; and
means for detecting an anomaly representative of an SQL injection attack based on the normal Database and Web application SQL query data and the real-time Database and Web application SQL query data.

2. The system of claim 1, wherein the learning means includes:
means for determining Database layer attributes; and
means for determining Web application layer attributes.

3. The system of claim 2, wherein the means for determining the Database layer attributes includes: means for sniffering traffic between a web server and a database of the website.

4. The system of claim 2, wherein the means for determining the Database layer attributes includes means for obtaining the Database layer attributes from a database auditing feature.

5. The system of claim 2, wherein the means for determining the Database layer attributes includes means for collecting SQL action data needed by the website.

6. The system of claim 2, wherein the Database layer attributes includes user data, action data, target object data and status code data.

7. The system of claim 6, wherein the Web application layer attributes includes at least one of status code, InTraffic to the website, OutTraffic from the website, and value length.

8. The system of claim 1, wherein the detecting means comprises:
means for generating a first anomaly score between the normal Web application SQL query data and the real-time Web application SQL query data; and
means for generating a second anomaly score between the normal Database SQL query data and the real-time Database SQL query data;
means for correlating the first anomaly score with the second anomaly score.

9. The system of claim 8, wherein the correlating means includes means for determining a joint score (S) between the first anomaly score (S1) and the second anomaly score (S2) defined by
S=S1×S2/(S1+S2).

10. The system of claim 1, wherein the detecting means is adapted to detect 0-day SQL injection attacks.

11. The system of claim 1, where the system has no means of predicting as to what a signature/pattern attack resembles.

12. A computer program product including a computer readable medium having instructions causing a computer to:
learn normal Database and Web application standard query language (SQL) query data for a website;
capture real-time Database and Web application SQL query data for the website; and
detect an anomaly representative of an SQL injection attack based on the normal Database and Web application SQL query data and the real-time Database and Web application SQL query data.

13. The computer program product of claim 12, wherein instructions to learn includes instructions causing the computer to:
determine Database layer attributes; and
determine Web application layer attributes.

14. The computer program product of claim 13, wherein the instructions to determine the Database layer attributes includes instructions causing the computer to:
sniffer traffic between a web server and a database of the website.

15. The computer program product of claim 13, wherein the instructions to determine the Database layer attributes includes instructions causing the computer to:
obtain the Database layer attributes from a database auditing feature.

16. The computer program product of claim 13, wherein the instructions to determine the Database layer attributes includes instructions causing the computer to:
collect SQL action data needed by the website.

17. The computer program product of claim 13, wherein the Database layer attributes includes user data, action data, target object data and status code data.

18. The computer program product of claim 17, wherein the Web application layer attributes includes at least one of status code, InTraffic to the website, OutTraffic from the website, and value length.

19. The computer program product of claim 2, wherein the instructions to detect includes instructions causing the computer to:
generate a first anomaly score between the normal Web application SQL query data and the real-time Web application SQL query data;
generate a second anomaly score between the normal Database SQL query data and the real-time Database SQL query data; and
correlate the first anomaly score with the second anomaly score.

20. The computer program product of claim 19, wherein the instructions to correlate includes instructions causing the computer to:
determine a joint score (S) between the first anomaly score (S1) and the second anomaly score (S2) defined by
S=S1×S2/(S1+S2).

21. The computer program product of claim 12, wherein the instructions to detect are adapted to detect 0-day SQL injection attacks.

22. The computer program product of claim 12, where instructions have no means of predicting as to what a signature/pattern attack resembles.

23. A method comprising the steps of:
learning normal Database and Web application standard query language (SQL) query data for a website;
capturing real-time Database and Web application SQL query data for the website; and
detecting an anomaly representative of an SQL injection attack based on the normal Database and Web application SQL query data and the real-time Database and Web application SQL query data.

24. The method of claim 23, wherein the learning step includes the steps of:
determining Database layer attributes; and
determining Web application layer attributes.

25. The method of claim 24, wherein the determining the Database layer attributes step includes the step of: sniffering traffic between a web server and a database of the website.

26. The method of claim 24, wherein the determining the Database layer attributes step includes the step of: obtaining the Database layer attributes from a database auditing feature.

27. The method of claim 24, wherein the determining the Database layer attributes step includes the step of collecting SQL action data needed by the website.

28. The method of claim 24, wherein the Database layer attributes includes user data, action data, target object data and status code data.

29. The method of claim 28, wherein the Web application layer attributes includes at least one of status code, InTraffic to the website, OutTraffic from the website, and value length.

30. The method of claim 23, wherein the detecting step comprises the steps of:
generating a first anomaly score between the normal Web application SQL query data and the real-time Web application SQL query data;
generating a second anomaly score between the normal Database SQL query data and the real-time Database SQL query data; and
correlating the first anomaly score with the second anomaly score.

31. The method of claim 30, wherein the correlating step includes the step of determining a joint score (S) between the first anomaly score (S1) and the second anomaly score (S2) defined by
S=S1×S2/(S1+S2).

32. The method of claim 23, wherein the detecting step includes detecting 0-day SQL injection attacks.

33. A system comprising:
a processor operable to execute a sequence of instructions to learn normal Database and Web application standard query language (SQL) query data for a website in a learning mode, capture real-time Database and Web application SQL query data for the website in a detection mode, and detect an anomaly representative of an SQL injection attack based on the normal Database and Web application SQL query data and the real-time Database and Web application SQL query data in the detection mode; and
memory coupled to the processor for storing the results from the learning mode and detection mode.

34. The system of claim 33, wherein the processor when operable to learn or capture is operable to execute instructions to determine Database layer attributes and determine Web application layer attributes.

35. The system of claim 34, wherein the processor when operable to determine the Database layer attributes is further operable to sniffer traffic between a web server and a database of the website.

36. The system of claim 34, wherein the processor when operable to determine the Database layer attributes is further operable to obtain the Database layer attributes from a database auditing feature.

37. The system of claim 34, wherein the processor when operable to determine the Database layer attributes is further operable to collect SQL action data needed by the website.

38. The system of claim 34, wherein the Database layer attributes includes user data, action data, target object data and status code data.

39. The system of claim 38, wherein the Web application layer attributes includes at least one of status code, InTraffic to the website, OutTraffic from the website, and value length.

40. The system of claim 33, wherein the processor when operable to detect is further operable to:
generate a first anomaly score between the normal Web application SQL query data and the real-time Web application SQL query data;
generate a second anomaly score between the normal Database SQL query data and the real-time Database SQL query data; and
correlate the first anomaly score with the second anomaly score.

41. The system of claim 40, wherein the processor when operable to correlate is further operable to:
determine a joint score (S) between the first anomaly score (S1) and the second anomaly score (S2) defined by
S=S1×S2/(S1+S2).

42. The system of claim 33, wherein the processor when operable to detect is adapted to detect 0-day SQL injection attacks.

43. The system of claim 33, where instructions have no means of predicting as to what a signature/pattern attack resembles.
